(19) United States
(12) Patent Application Publication
(10) Pub. No.: US 2009/0304487 A1
(43) Pub. Date: Dec. 10, 2009

(54) APPARATUS AND METHOD FOR MANIPULATING CONTAINERS

(76) Inventor: Almada Gonzalo, Miami, FL (US)

Correspondence Address: FOLEY AND LARDNER LLP;SUITE 500, 3000 K STREET NW, WASHINGTON, DC, 20007, US

(21) Appl. No.: 12/421,483

(22) Filed: Apr. 9, 2009

Related U.S. Application Data
(60) Provisional application No. 61/043,849, filed on Apr. 10, 2008.

(51) Int. Cl. B66F 11/00; B66C 23/48; B66C 23/36; B66C 23/18; B66F 9/02; B66F 9/065; B66F 9/06

(52) U.S. Cl. 414/738

(57) ABSTRACT

An apparatus for manipulating and lifting an object can include a frame and an arm, at least one first device configured to lift the arm, and a second device configured to lower the arm. The frame and arm can be configured such that the object is secured to the arm so that the object is lifted when the arm is lifted or raised.

This application claims the benefit of U.S. Provisional Application No. 61/043,849, filed Apr. 10, 2008, which is hereby incorporated by reference in its entirety.

### FIELD OF THE INVENTION

The present invention relates to the field of equipment used for manipulating and lifting objects, such as containers.

### BACKGROUND

The market for bottled water and larger water dispenser systems is actively growing. To meet this demand for clean, potable water, a variety of approaches have been tried including in situ filtration or sourcing from deep artesian wells. Regardless of the source, i.e., filtered water or spring water, the product is usually delivered to consumers in containers, such as bottles. For small demand applications such as households, the water is often purchased in small single serving bottles. Commercial and business environments often purchase large format containers such as five gallon glass or plastic bottles, which are used in conjunction with a dispenser, to deliver hot or cold water on demand. The convenience of this delivery format, along with a reduction in packaging waste over other formats, has resulted in household consumers adopting large water dispensers for home use as well.

### SUMMARY

The present invention provides an apparatus that can be used to lift various objects, such as, for example, a container, with little or no effort.

For example, large format containers suffer from one primary disadvantage, which is weight. Water weighs one kilogram per liter, or about 8.4 pounds per gallon. A five gallon water container, commonly found in the U.S., can weigh in excess of forty pounds. In addition to the weight, the container is bulky and awkward to lift. For use with most dispensers, the container must be lifted by about three feet and then inverted in order to be installed into a top-feeding dispenser unit. The effort required to lift and invert the container is beyond the physical capability of many people in society, such as young children, elderly individuals, and persons of small stature or comparatively low muscle mass.

Accordingly, while the popularity of water dispensers has increased, there remains a need for an improved apparatus to manipulate and lift large format water bottles.

According to an embodiment, an apparatus for manipulating and lifting an object, can include a frame, wherein the frame comprises an arm, wherein the arm is configured such that the object is secured to the arm so that the object is lifted when the arm is lifted or raised, at least one first device configured to lift the arm, and a second device configured to lower the arm.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a side view of an apparatus for manipulating and lifting an object, with the apparatus in a lifted position, according to an embodiment.

FIG. 2a is an end view of the apparatus of FIG. 1, with the apparatus in a lowered position.

FIG. 2b is a side view of the device of FIG. 1, with the apparatus in a lowered position.

FIG. 3 is a side view of a frame of an apparatus for manipulating and lifting an object, according to an embodiment.

FIG. 4a is an end view of a first frame member of the frame of FIG. 3.

FIG. 4b is a side view of the first frame member of the frame of FIG. 3.

FIG. 5a is an end view of a second frame member of the frame of FIG. 3.

FIG. 5b is a side view of the second frame member of the frame of FIG. 3.

FIG. 6a is a side view of an arm of an apparatus for manipulating and lifting an objection, according to an embodiment.

FIG. 6b is a top view of the arm of FIG. 6a.

FIG. 7 is a side view of an apparatus for manipulating and lifting an object, with the apparatus in a lowered position, according to an embodiment.

FIG. 8 is a side view of the apparatus of FIG. 7, with the apparatus in a lifted position.

FIG. 9 is an end view of the apparatus of FIG. 8.

FIG. 10 is a top view of the apparatus of FIG. 8.

FIG. 11 is a side view of the apparatus of FIG. 7, with the apparatus in a lowered position after an object has been removed from the apparatus.

FIG. 12 is a side view of an apparatus for manipulating and lifting an object with the apparatus in a lowered position, according to an embodiment.

FIG. 13 is an end view of the apparatus of FIG. 12, with the apparatus in a raised position.

FIG. 14 is a side view of the apparatus of FIG. 13.

### DETAILED DESCRIPTION

The present invention provides an apparatus that can be used to manipulate and lift an object with little or no effort by a user of the apparatus. For example, the apparatus can be used to manipulate and lift a container, such as a container of a liquid, with little or no effort by a user. The apparatus may also be used to manipulate and lift other objects, such as loads, supplies, or other objects that may requiring lifting and would otherwise necessitate a physical burden on a person without assistance.

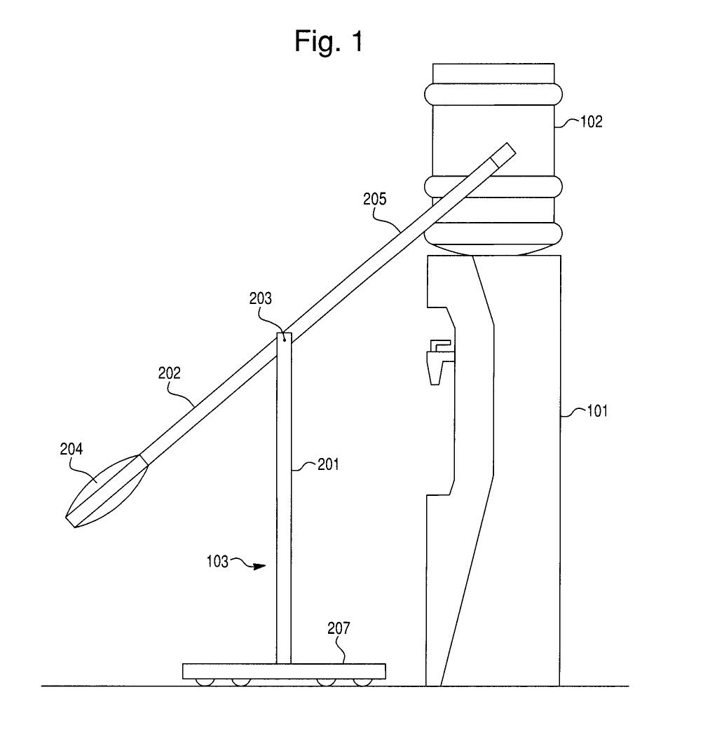

FIG. 1 shows a side view of an apparatus 103 for manipulating and lifting an object, according to an embodiment. The example of FIG. 1 depicts the apparatus 103 in a lifted position, with a full large format container 102, such as a water container, installed in a top-feeding dispenser unit 101 that the container 102 is adapted for. For example, a large format water container may hold, for example, about five U.S. gallons.

While the apparatus can be used to remove an empty water container, such containers are usually manufactured from plastic or other lightweight materials, and may not require the present apparatus for removal. However, the apparatus provides a convenient way to remove an empty container, such as glass containers that may weigh substantially more than plastic containers.

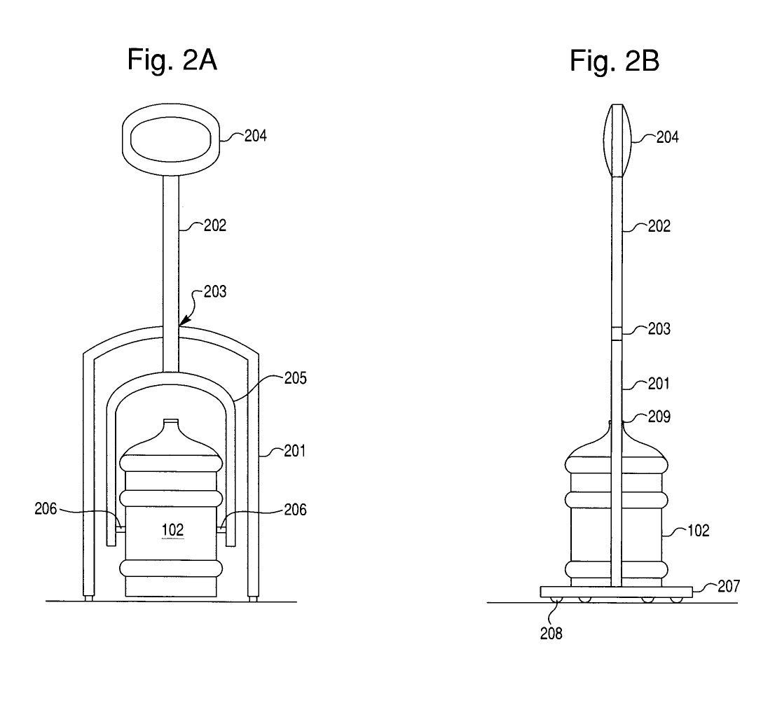

FIG. 2a shows an end view of the apparatus of FIG. 1 in a lowered position, such as when an object, such as a container 102, has been loaded into the apparatus for lifting or after an object has been lowered by the apparatus, while FIG. 2a shows a side view of the apparatus of Figure in the lowered position.

As shown in the example of FIGS. 1, 2a, and 2b, the apparatus 103 can include a base plate 207 upon which is disposed a first support element 201. A lever arm 202 can be pivotally connected to the first support element 201 at a pivot point 203. The lever arm 202 terminates at the distal end with a counterweight 204. The counterweight 204 can be fixed in position or can be slidably adapted or connected to the lever arm 203, such as to adjust the weight counterbalancing an object manipulated and lifted by the apparatus 103. The counterweight 204 is of sufficient mass such that it substantially reduces a weight of the container 102 perceived by a user, including any contents of the container 102. The appropriate mass and/or position for the counterweight 204 will depend on the length of the lever arm 202, weight of the container 102, and position of the pivot point 203 along the length of the lever arm 202. Such calculations as to appropriate counterweight 204 mass and position are within the capabilities of engineers and other skilled artisans in view of the teachings provided herein, a given configuration of the apparatus 103, and a given object to be manipulated and lifted.

At the proximal end of the lever arm 202, a second support element 205 is provided. The lever arm 202 and second support element 205 can be, for example, rigidly connected or joined, or the lever arm 202 and the second support element 205 can be separable to permit adjustment and/or replacement of the second support element 205, so as to permit the apparatus 103 to be used with various objects, such as an object other than a container 102.

The second support element 205 can be substantially rounded, and can terminate in two arms, the span of which is wider than a diameter of the object to be manipulated and lifted, such as a container 102. Arms of the second support element can include attachment devices 206 that can be pivotally connected to the arms of the second support element. A securing device (not shown), such as a strap extending around the container 102, can be used to secure and connect an object to be manipulated and lifted to the second support element 205 of the apparatus. Such a securing device can extend from the attachment devices 206 and engage with the container 102, thereby removably securing it to the apparatus. For example, the securing device can engage with a surface and/or contour of an object, such as a container 102, or engage with and/or extend around a circumference of an object, such as a container 102. In another example the attachment points 206 can include devices that directly engage with the container 102, such as a surface and/or a contour of the container 102.

As shown in the example of FIG. 2b, the base plate 207 can include a plurality of wheels 208 or other devices to assist in the movement and positioning of the apparatus. Such wheels 208 may move freely or may be driven. Such wheels 208 facilitate delivery of an object, such as a full container 102, to a desired destination, such as a dispenser unit 101 or a storage area for the apparatus 103.

Preferably, the base plate 207 can be substantially flat and of a size and shape that allows an object to be manipulated and lifted, such as a water container, to be placed on the base plate 207 for transport.

In operation of the apparatus, a user acquires an object to be manipulated and lifted, such as, for example, a container 102 filled with water, liquid, or another desired beverage. The container 102 can be placed on the base unit 207 so that the object can be secured to the apparatus 103. For example, a container 102 can be secured to the apparatus 103 via a securing device, such as a strap, or via the attachment points 206 using features on the container. Once the container 102 has been secured to the apparatus 103 the apparatus 103 can be positioned close to a desired destination, such as a dispenser 101.

With reference to FIGS. 1, 2a, and 2b, a user may then press down on the counterweight 204, causing the lever arm 202 to rotate about the pivot point 203 to thereby raise an object, such as a container 102, to a desired height, such as above a top of a dispenser unit 101. The counterweight 204 can be of sufficient mass such that the object, such as a container 102, remains at the desired height, thus permitting the user to let go of the apparatus without causing the container 102 to fall back to ground level.

The apparatus 103 can then be moved such that the lifted object is in a desired location, such as positioning the container 102 over the dispenser unit 101. In the example of manipulating and lifting the container 102, the user may then rotate the container 102 to thereby invert the container 102 such that the neck of the container 209 faces down, while simultaneously lowering the neck 209 of the container into the dispenser unit 101. With the container so positioned, the container can then be disengaged from the apparatus, such as by releasing the container from the securing device or attachment points 206. A user of the apparatus may then move the apparatus away from the desired location, such as the dispenser 101.

In a further example, the apparatus may be broken down and/or folded for storage. For example, the first and second support elements and the lever arm can be tubular and extensible, and the first support element can be adapted or connected to the base plate by hinges that can be locked into place during operation of the apparatus.

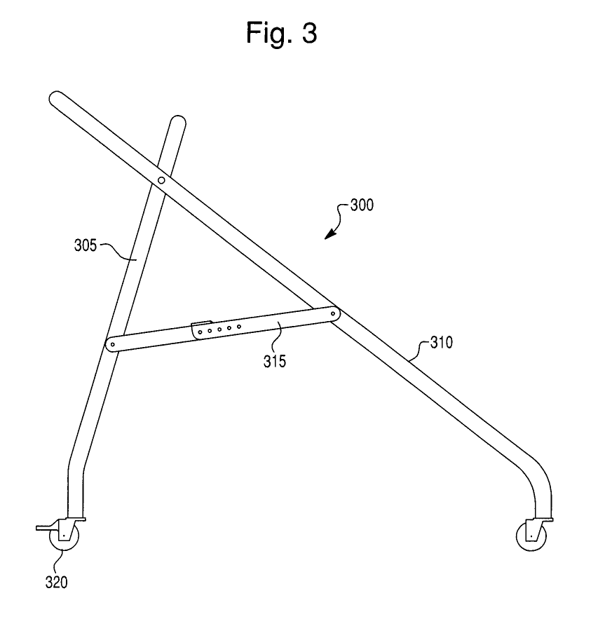

Another embodiment of an apparatus for manipulating and lifting an object is shown in FIGS. 3-11. FIG. 3 is a side view of a frame 300 for an apparatus for manipulating and lifting an object, according to this embodiment.

As shown in the example of FIG. 3, the frame 300 can include a first frame member 305 and a second frame member 310. Such frame members can be formed by, for example, tubes, beams, flat pieces, or other structures, and can be made from, for example, metal, plastic, or other materials, such as aluminum, nylon, or other materials. In addition, the first frame member 305 and the second frame member 310 can be joined by a member 315, such as a brace, to provide additional stability to the frame 300, if needed, as shown in the example of FIG. 3. The frame 300 can be adjustable so that the height and/or width of the frame 300 can be adjusted, such as to adapt the frame 300 for different objects of different size and/or weight to be manipulated and lifted by an apparatus that includes the frame 300. For example, the first frame member 305, second frame member 310, and member 315 can be adjustable in length, such as by telescopic extension of each of these components to different lengths. In another example, the frame 300 can be adjusted to provide different heights that an object can be lifted to.

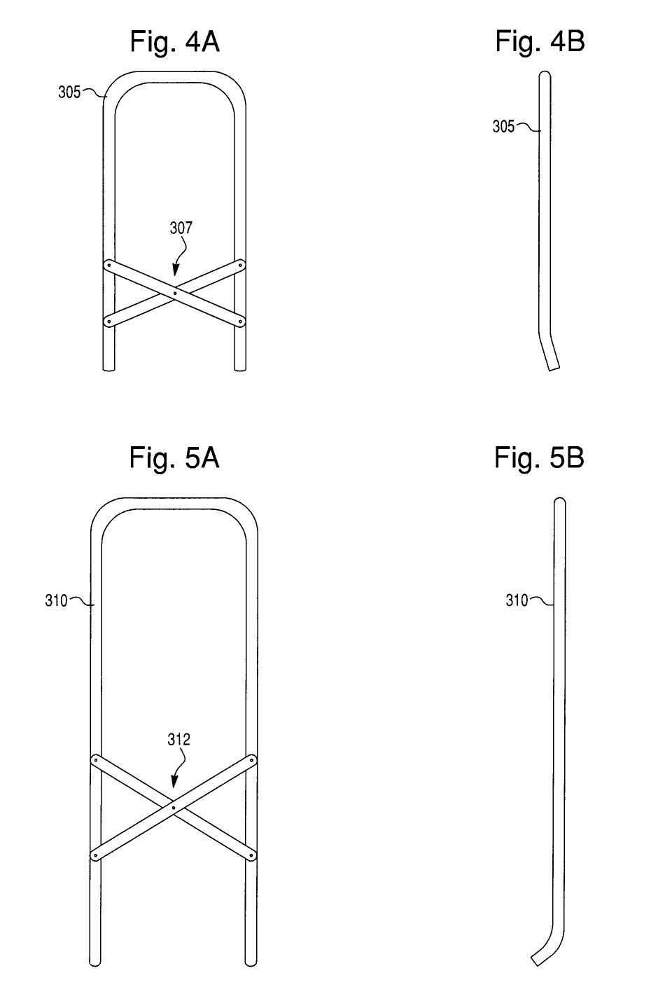

FIG. 4a shows an end view of a first frame member 305 and FIG. 4b shows a side view of the first frame member 3-5. FIG. 5a shows an end view of a second frame member 310 and FIG. 5b shows a side view of the second frame member 310. As shown in the examples of FIGS. 4a and 5a, the first frame member 305 and the second frame member 310 can include members 307 and 312, such as braces, to provide additional stability, if needed. Such members 307, 312 can be adjustable for objects of different size and/or weight, as described above.

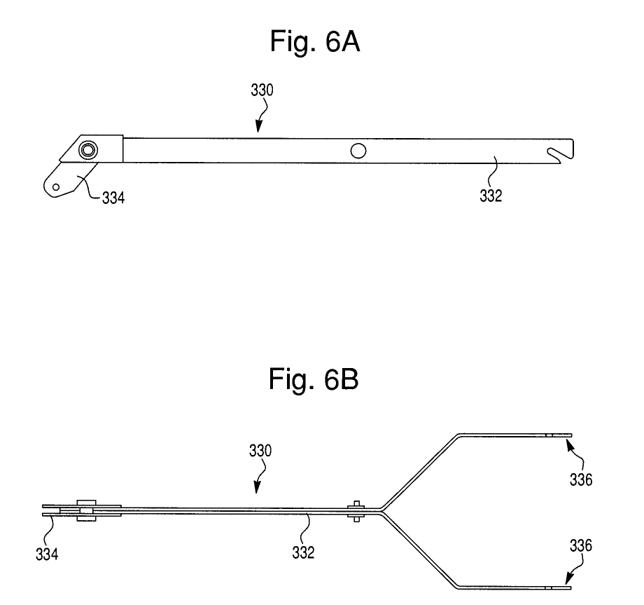

FIG. 6a shows a side view of an arm 330 for an apparatus to manipulate and lift an object. FIG. 6b shows a top view of the arm 330 of FIG. 6a. As shown in the example of FIGS. 6a, and 6b, the arm 330 can include an arm member 332 and a plate 334. The arm member 332 and the plate 334 can be joined together or otherwise connected, as shown in the examples of FIGS. 6a and 6b. As will be discussed below, the arm 330 engages with an object to be manipulated and lifted. Furthermore, as shown in the example of FIG. 6b, the arm 330, particularly the arm member 332, can have a general U-shape or fork shape, with distal ends 336. The arm 330 can be adjustable so that the arm 330 can be modified for different objects to be manipulated and lifted, such as by telescopically extending or compressing the arm 330. In particular, the arm member 332 can be adjusted for different objects or different sizes and/or weights. In another example the arm 330 can be adjusted to provide different heights that an object can be lifted to.

The arm member 332 can include a securing device 440, such as a strap or belt extending around an object to be manipulated and lifted, such as a container. The securing device can be used to secure and connect the object to be manipulated and lifted to the arm 330 of the apparatus, particularly the arm member 332. Such a securing device can extend from the distal ends 336 and engage with the object, thereby removably securing it to the arm 330. For example, the securing device can engage with a surface and/or contour of an object, such as a container, or engage with and/or extend around a circumference of an object, such as a container, to lock the object to the apparatus, such as by using a belt with a clamp. In another example the distal ends 336 can each have a manual lock that engages with a securing device to connect the securing device and object to the arm 330. In another example, the securing device 440 can be a belt that engages with and/or extends around a circumference of an object, such as a container 500. The container 500 can be a water container or a container for another beverage or liquid. In another example the securing device can be a flat platform attached to the distal end of the arm that an object can be placed upon or secured to. In another example the distal ends 336 can include devices that directly engage with the object, such as a container, such as a surface and/or a contour of the object. The securing device, or the distal ends 336, can be adjusted to adapt to different objects of different sizes and/or weights, such as by adjusting the position of the securing device or distal ends 336. In another example, the arm 330 can include a lock to hold the arm 330 in a desired position, such as during movement and positioning of the apparatus. Such a lock can be used for any position of the arm 330, such as a lowered or raised position, and whether the apparatus is engaged with an object or not. In another example, the arm 330 can include a lock that is automatically engaged when the arm 330 is raised to a lifted position.

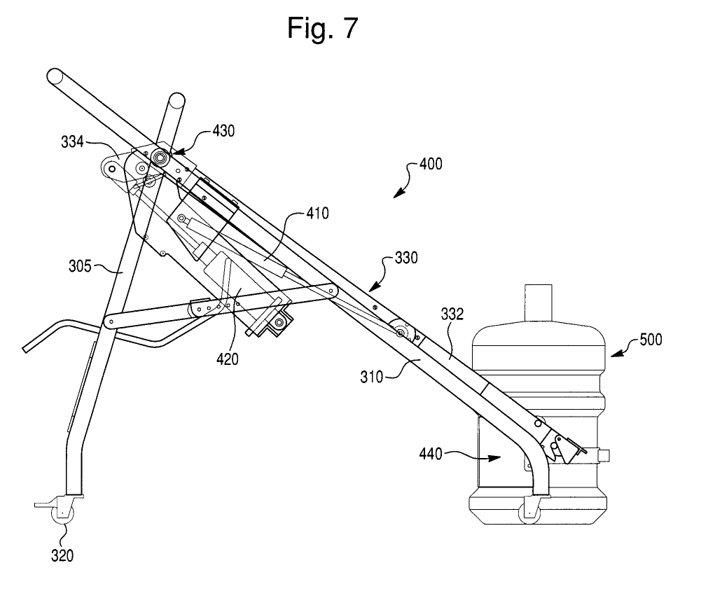

FIG. 7 shows a side view of another embodiment of an apparatus 400 for manipulating and lifting an object according to the invention. As shown in the example of FIG. 7, the apparatus 400 can include at least one first device 410 to lift or raise the arm 330 of the apparatus 400, causing an object, such as a container 500, to be manipulating and lifted. The apparatus can further include a second device 420 to lower the arm 330. For example, the second device 420 can be configured to counteract the first device 410 to lower the arm 330, such as by exerting a force that counteracts a force provided by the first device 410.

The first device 410 can be configured to exert a force that causes the arm 300 of the apparatus 400 to be lifted upwards, such as by rotating the arm 300 about a pivot point 430 in the frame of the apparatus 400, thus causing an object, such as a container 500 to be lifted upwards. The arm 330 can be joined or directly connected to the pivot point 430 of the frame 300 of the apparatus 400, such as by extending a shaft through a hole in the arm 330. For example, the arm member 332 and the plate 334 can both be connected to the pivot point 430 of the frame, such as by extending a shaft through respective holes in each of the arm member 332 and the plate 334.

As shown in the example of FIG. 7, the first device 410 can be connected or joined to a frame of the apparatus 400 and the arm 330, such as the arm member 332 of the arm 330. The first device 410 and the structure of the apparatus 400, including the frame 300 and the arm 330, can be configured such that an object to be manipulated and lifted is balanced, such that the object and arm 330 can be easily moved by a user with little exertion or force.

The first device 410 can be, for example, a spring, hydraulic device, piston/cylinder device, motor, engine, rack and pinion, gear set, any combination of these devices, or any other type of actuator used in the art. For example, the first device 410 can be the type of device used to open a deck lid or trunk lid of an automobile. In another example, the first device 410 can further include a device to limit the amount of motion and/or force the first device 410 imparts the arm, such as a damper.

The first device 410 can be configured such that the first device 410 does not manipulate and lift the arm 330, and thus an object, until a user provides input to the first device 410. For example, the first device 410 may be configured to not manipulate and lift the arm 330 until a user provides a predetermined amount of force to the arm 330, the object, and/or the first device 410. In such an example, the predetermined amount of force is necessary to overcome a predetermined amount of resistance provided by the first device 410. For example, the predetermined amount of force necessary to overcome the predetermined amount of resistance can be 1 to 5 pounds of force, or more particularly 2 or 3 pounds of force. Once at least the predetermined amount of force has been applied the first device 410 can freely cause the arm 330 to be lifted upwards. In another example, the first device 410 can be activated by a control device, such as a button, switch, lever, or other locally or remotely controlled control device used in the art, or the first device 410 can be activated by a signal provided by a control device, such as an electronic control device or central processing unit. In a further example, a control device can be used to vary the amount of force exerted by the first device 410, such as to adjust the apparatus for manipulating and lifting objects of different sizes and/or weights, and/or lifting objects to different heights.

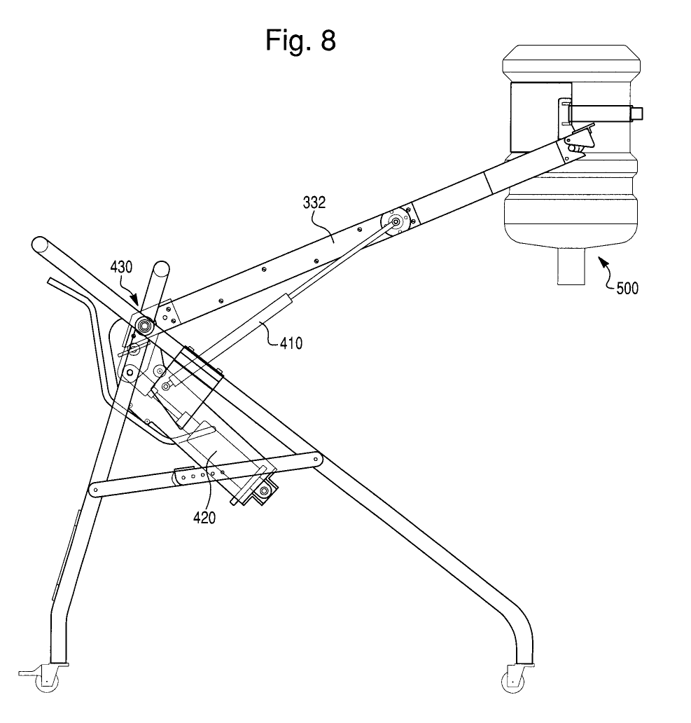

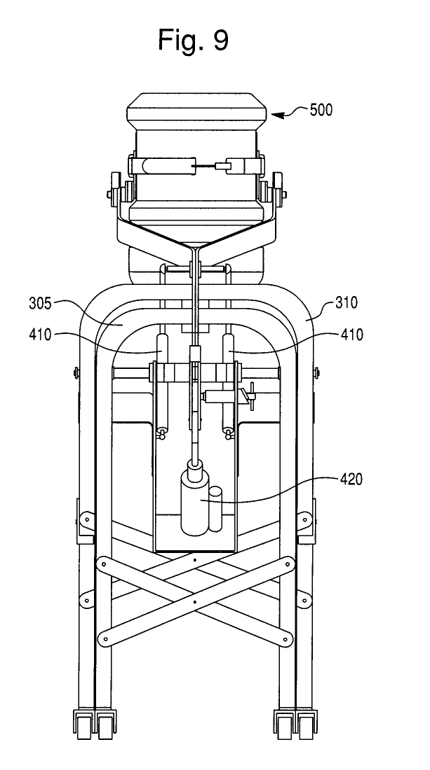

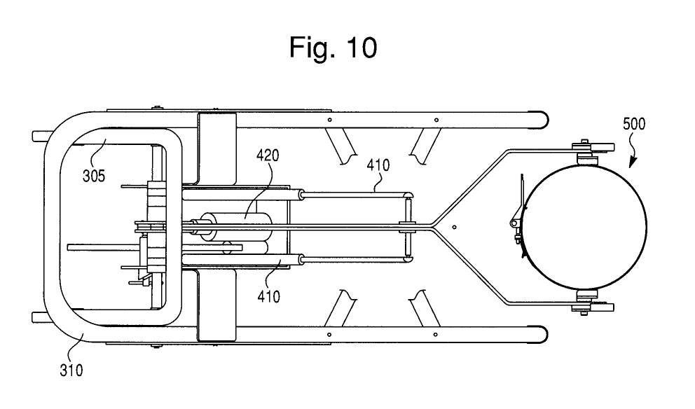

The first device 410 can be configured such that once the first device 410 has been activated to manipulate and lift the arm 330, and thus an object, the arm is maintained in the lifted position, as shown in the example of FIG. 8. For example, the first device 410 can be configured to lock the arm 330 into a raised position once the arm 330 has been raised, such as to manipulate and lift an object. In another example, the arm 330 can include a lock to hold the arm 330 in a position, such as a lowered position, such that when the lock is released the first device 410 automatically raises the arm 330 to a raised and lifted position when the second device 420 is not exerting a force to lower the arm 330. FIG. 9 shows an end view of the apparatus 400 of FIG. 7 in the lifted position and FIG. 10 shows a top view of the apparatus 400 of FIG. 7 in the lifted position. As shown in the example of FIG. 10, the apparatus 400 can include more than one first device 410, such as two first devices 410. However, the apparatus 400 can have different configurations for the first device 410, such as one first device 410, two first devices 410, or three or more first devices 410. Such configurations may be selected in anticipation of the size and/or weight of an object to be manipulated and lifted by the apparatus 400.

Once the arm 330 has been lifted to this position an object secured to the arm, such as a container 500, may be further manipulated. For example, a container lifted by the apparatus 400 can be rotated such that the container 500 is positioned upside-down, as shown in the example of FIG. 8. The apparatus 400 can also be moved while the arm 330 is in this lifted position, or before or after the arm 330 is lifted, such as by using wheels 320 attached to a frame of the apparatus 400. The first device 410 can maintain this lifted position of the arm 330 until the first device 410 is controlled to lower the arm 330, such as by providing a counteracting force to the first device 410 or a control input or signal to the first device 410. For example, the first device 410 may be configured to provide a predetermined amount of force to lift the arm 330, and thus the object. For example, the predetermined amount of force exerted by the first device 410 can be three hundred pounds or more. In such a configuration, the second device 420 can be configured to lower the arm 330 of the apparatus 400, such as by exerting a force that counteracts a force provided by the first device 410.

The second device 420 can be, for example, a pump, motor, engine, rack and pinion, gear set, hydraulic device, piston/cylinder device, any combination of these devices or any other type of actuator used in the art. In another example, the second device 420 can be a pump or jack, such as one used to control lifting and lowering a car, such as when changing a tire.

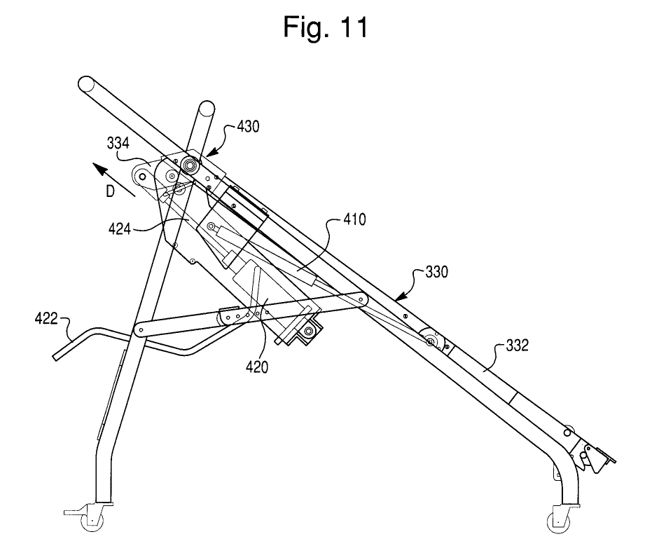

As shown in the example of FIG. 11, which shows a side view of the apparatus 400 of FIG. 7 after an object, such as a container 500, has been removed and the arm 330 has been lowered, the second device 420 can be joined or connected to the frame of the apparatus 400 and the arm 330. For example, the second device 420 can be connected to the plate 334 of the arm 330, such as via a shaft 424 of the second device 420.

The second device 420 may further include a control input, such as a lever 422, that an user may use to actuate the second device 420. In the example of providing a pump or jack as the second device 420, the lever 422 can be used to actuate the second device 420, such as to extend the shaft 424, by moving the lever 422 back and forth or up and down. Furthermore, the lever 422 or a valve can be used to release the force or pressure exerted by the pump or jack in this example.

For example, the second device 420 may be actuated by the lever 422 to cause the shaft 424 to extend outwards from the second device 420, such as in the direction indicated by arrow D in the example of FIG. 11. In this example, the shaft 424 is connected to the arm 330, such as the plate 334 of the arm 330. Thus, when the shaft 424 of the second device 420 is extended, the arm 330 is forced to pivot about the pivot point 430 by the force or pressure exerted by the second device 420, causing the arm 330 to be lowered. In such an example the second device 420 can be used to exert a force that counteracts a force exerted by the first device 410, causing the arm 330 to be lowered in a controlled manner, for example at a controlled rate of speed. Those of ordinary skill will recognize that the characteristics of the second device 420 can be set or adjusted to control the characteristics of the descent of the arm 330.

The apparatus can include a single second device 420, as shown in the example of FIGS. 7-11, or the apparatus can include more than one second device 420, as may be desired for manipulating and lifting objects of different sizes and/or weights.

In another example, the second device 420 can be activated by a control device, such as a button, switch, lever, or other control device used in the art, or the second device 420 can be activated by a signal provided by a control device, such as an electronic control device or central processing unit. In a further example, a control device can be used to vary the amount of force exerted by the second device 420, such as to adjust the apparatus for manipulating and lifting objects of different sizes and/or weights, and/or lowering the arm and objects to different heights.

An example of the operation of the apparatus 400 will now be discussed. Prior to operation the apparatus can be stored, such as by folding or disassembling the apparatus. As shown in the example of FIG. 7, the apparatus 400 can be removed from storage and provided with the arm 330 in a lowered position so that an object, such as a container 500, can be secured or attached to the apparatus, such as by using the securing device or the distal ends 336 of the arm 330. The apparatus 400 can be moved and positioned before and/or after the object has been secured to the device. Once the object has been secured to the apparatus 400, the first device 410 can be actuated, as described above, to manipulate and lift the arm 330, and thus the object, to a desired height, as shown in the example of FIG. 8. In the example of the apparatus that uses a jack as the second device 420, the lever 422 or a valve can be opened to permit the arm to move. In an example of the apparatus that uses a lock for the arm 330, the lock is opened to permit the arm 330 to be raised. The apparatus 400 can be moved and positioned once the arm 330 has been lifted, such as to position the object in a desired location, such as by positioning a container relative to a dispenser. If the arm 330 includes a lock, the lock may be engaged to maintain the arm 330 in a raised position once the arm 330 has been raised. The object may then be manipulated to further position the object and the object may be removed from the apparatus 400, such as by removing the securing device or removing the object from the distal ends 336 of the arm 330. Next, the arm 330 may be lowered by actuating the second device 420, as described above, to lower the arm 330 to a lowered position, as shown in the example of FIG. 11. If the arm 330 includes a lock, the lock may then be engaged to maintain the arm 330 in a lowered position, such as when the apparatus is configured such that the first device 410 automatically raises the arm 330 when the lock is not engaged and the second device 420 is not exerting a force to counteract the force of the first device 410. Once operation of the apparatus 400 is complete, the apparatus 400 can be folded or disassembled for storage until further use is needed.

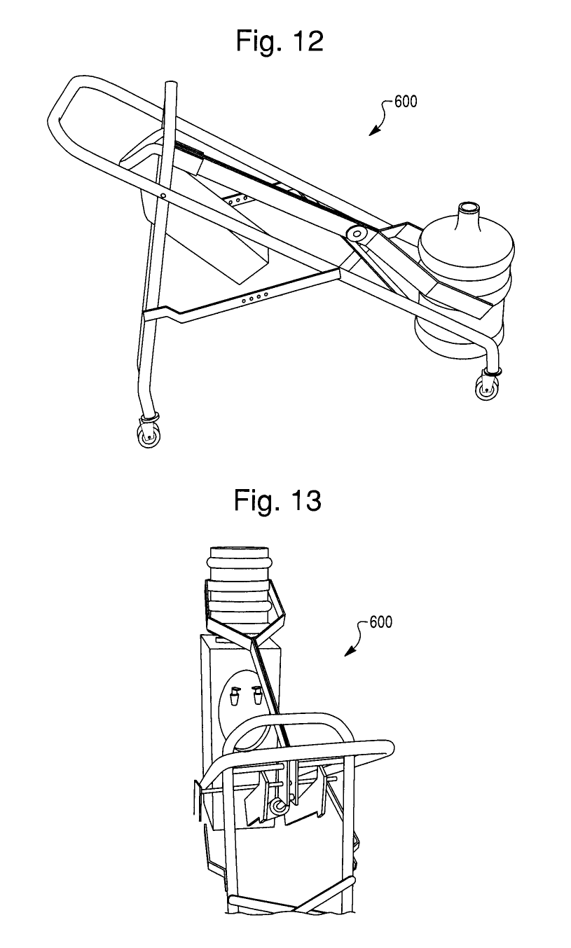

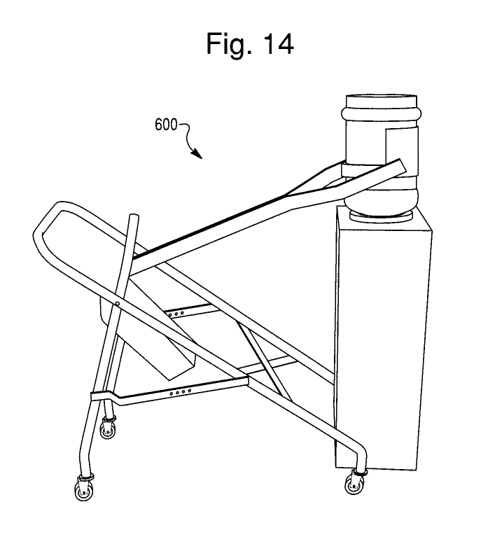

FIG. 12 is a side view of an apparatus 600 for manipulating and lifting an object, such as a container, with the apparatus in a lowered position, according to an embodiment. FIG. 13 is an end view of the apparatus of FIG. 12, with the apparatus in a raised position and FIG. 14 is a side view of the apparatus of FIG. 13. As shown in the examples of FIGS. 12-14, the apparatus 600 can be used to manipulate and lift a container, such as a container of water, a beverage, or another liquid, to a sufficient height so that the container may be manipulated and positioned relative to a desired location, such as on a dispenser.

It can be appreciated from the foregoing that a new apparatus for manipulating and lifting objects has been developed. While the apparatus and its methods of use have been described herein as applied to the handling of water containers, other objects and types of fluids and container systems are capable of manipulation with the present device. These equivalents are considered to be within the scope of the invention in view of the teachings provided herein.

What is claimed is:

1. An apparatus for manipulating and lifting an object, comprising:
a frame, wherein the frame comprises an arm,
wherein the arm is configured such that the object may be secured to the arm so that the object may be lifted when the arm is lifted or raised,
at least one first device configured to lift the arm, and
a second device configured to lower the arm.

2. The apparatus of claim 1, wherein the second device is configured to lower the arm by counteracting a force exerted by the at least one first device to lift the arm.

3. The apparatus of claim 2, wherein the arm pivots about a pivot point in the frame.

4. The apparatus of claim 1, wherein the arm includes a securing device to secure the object to the arm.

5. The apparatus of claim 1, wherein the arm includes distal ends configured to secure the object to the arm.

6. The apparatus of claim 2, wherein the apparatus is adjustable so that the apparatus can be configured to lift objects of different sizes and/or weights.

7. The apparatus of claim 6, wherein the frame is adjustable in length.

8. The apparatus of claim 6, wherein the at least one first device is adjustable such that a force exerted by the at least one first device to lift the arm is adjustable.

9. The apparatus of claim 6, wherein the second device is adjustable such that a force exerted by the second device to counteract the force exerted by the at least one first device to lift the arm is adjustable.

10. The apparatus of claim 1, wherein the at least one first device is a spring, hydraulic device, piston/cylinder device, motor, engine, rack and pinion, gear set, or any combination thereof.

11. The apparatus of claim 1, wherein the second device is a pump, jack, motor, engine, rack and pinion, gear set, hydraulic device, piston/cylinder device, or any combination thereof.

12. The apparatus of claim 1, wherein the at least one first device is configured to lift the arm once a predetermined amount of force has been applied to overcome a predetermined amount of resistance provided by the at least one first device.
